(19) United States
(12) Patent Application Publication
(10) Pub. No.: US 2009/0004449 A1
(43) Pub. Date: Jan. 1, 2009

(54) Cutting insert with a wear-resistant coating scheme exhibiting wear indication and method of making the same

(76) Inventors: Zhigang Ban, Latrobe, PA (US); Mark J. Rowe, New Derry, PA (US); Yixiong Liu, Greensburg, PA (US); Alfred S. Gates, JR., Greensburg, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 11/823,679

(22) Filed: Jun. 28, 2007

(51) Int. Cl. B32B 7/02; B05D 1/36; B32B 15/04

(52) U.S. Cl. 428/216; 427/419.1; 428/457

(57) ABSTRACT

A coated cutting insert for use in a chip-forming material removal operation wherein the coated cutting insert includes a substrate that has a flank surface and a rake surface and the flank surface intersects the rake surface to form a cutting edge at the intersection. There is a wear-resistant coating scheme that adheres to at least a portion of the substrate. The wear-resistant coating scheme includes one or more coating layers of one or more of alumina, hafnia and zirconia. There is a wear indicating coating that adheres to at least a portion of the wear-resistant coating scheme. The wear indicating coating includes M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0. A method of making a cutting insert with wear indicating including the steps of: providing a substrate with an outer alumina coating layer; applying an as-deposited non-wear indicating coating layer to the alumina coating layer; and treating the non-wear indicating coating layer to convert it to a wear indicating coating layer.

### BACKGROUND OF THE INVENTION

The present invention relates to a coated cutting insert with a wear-resistant coating scheme that exhibits wear indication and a method of making the same. More specifically, the invention pertains to a coated cutting insert with a wear-resistant coating scheme that exhibits wear indication via visually contrasting colors of an outer wear-indicating coating layer that operatively adheres to an alumina coating layer, as well as a method of making the coated cutting insert.

Milling cutters and other tools used for the removal of material from a workpiece (e.g., machining of a workpiece) sometimes present one or several cutting inserts. Each one of these cutting inserts exhibits a certain tool life so that from time-to-time the operator must replace the used cutting inserts with unused cutting inserts. The operator will make a complete replacement of the cutting insert when it has only one cutting edge. In reference to a cutting insert with multiple cutting edges, the operator will index the cutting insert to expose an unused cutting edge when the engaged cutting edge nears the end of its useful tool life.

It can be detrimental to the overall material removal operation for a used cutting edge to be placed back in service. Thus, it would be advantageous to identify easily a used cutting edge to avoid placing a used cutting edge back in service.

Heretofore, there have been coating schemes for cutting inserts useful to detect the use of a specific cutting edge. In this regard, U.S. Pat. No. 6,682,274 B2 to Vötsch et al. pertains to a coated cutting insert with wear indicating properties wherein the flank or flanks of the cutting insert according to the invention is (are) provided with a wearable indicating layer, having a color that differs from the color of the surface or layer underneath. The wear indicating coating layer does not extend to the cutting edge and is “sensitive enough, so that even a short-term use of the adjacent cutting edge leaves clear traces on the indicating layer.” See Abstract.

European Patent Application No. 1 757 389 A1, which was not published until Feb. 28, 2007 (the PCT equivalent (PCT WO 2006/067956) carries a publication date of Jun. 29, 2006), appears to disclose a coating arrangement on the surface of a cutting tool that comprises four basic layers. The layers are in the following order moving out from the substrate: third layer (next to substrate), first layer, second layer and fourth layer. The first layer is underneath the second layer and comprises titanium boronitride (TiBN) or titanium boron-oxynitride (TiBNO). The second layer is, “. . . implemented as a single layer or a plurality of layers, by at least one selected from the group consisting of aluminum oxide, zirconium oxide, hafnium oxide and a solid solution mainly including two or more of these components, and the second coating layer is located directly on the first coating layer.” The third layer is between the first layer and the substrate and includes TiC, TiN, TiCN, TiCNO, TiB₂, TiBN, TiCBN, ZrC, ZrO₂ HfC, HfN, TiAIN, AlCrN, CrN, VN, TiSiN, TiSiCN, AlTiCrN, and TiAlCN. The fourth layer is the coating layer that functions as a wear indicating coating layer and can include TiCNO and is removed from the cutting area by blasting.

Kennametal Inc. of Latrobe, Pa. 15650 United States of America makes and sells a commercial prior art coated cutting insert. This prior art coated cutting insert presents a coating scheme as follows: a titanium nitride base coating layer on the substrate, a titanium carbonitride coating layer on the titanium nitride coating layer, a bonding layer that includes Ti, Al, O, C and N on the titanium carbonitride coating layer and an alpha-alumina coating layer on the bonding layer. During the manufacture of the prior art cutting insert, a titanium nitride/titanium carbonitride coating layer is applied to the alpha-alumina coating layer and then removed by blasting whereby the alpha-alumina coating layer experiences reduced tensile residual stress or compressive residual stress.

U.S. Pat. No. 7,153,562 to Rodmar et al. pertains to a coated cutting insert that includes a TiCON layer and wherein the titanium carbonitride is the outer coating layer.

U.S. Pat. No. 6,472,060 to Ruppi et al., as well as related issued patents U.S. Pat. No. 6,620,498 to Ruppi et al. and U.S. Pat. No. 6,652,913 to Ruppi et al., pertains to a coated cutting insert that includes in the coating scheme a nanocrystalline coating of Ti(C,N,O) applied via a MTCVD process at a temperature that ranges between 700-900° C. See Column 2, lines 36-45.

United States Patent Application Publication No. US2006/0257690 to Bjormander (European Patent Application No. 1 717 348 A2 is the European counterpart) pertains to a coated cutting tool insert wherein the post-treatment (preferably blasting or brushing) removes the outermost coating layer on the edge-line and on the rake face.

European Patent Application No. 1 734, 155 A1 to Littecke et al. (applicant is Sandvik Intellectual Property AB), which has a United States counterpart in United States Published Patent Application No. US 2007/0009763A1, pertains to a CVD-coated cutting tool wherein alumina is the outer coating layer.

In addition to European Patent Application No. 1 757 389, mechanical treatments such as shot peening to reduce the tensile residual stresses or create compressive residual stresses in a coating of a cutting tool is not new. U.S. Pat. No. 5,681,651 to Yoshimura et al. discloses shot peening to effectively control the magnitude and type of residual stresses in the shot peened coatings and underlying coating. Other patents that disclose shot peening or the like include U.S. Pat. No. 5,576,093 to Yoshimura et al., U.S. Pat. No. 5,372,873 to Yoshimura et al., and U.S. Pat. No. 5,374,471 to Yoshimura et al., U.S. Pat. No. 4,674,365 to Reed, and U.S. Pat. No. 6,884,496 to Westphal et al. (based upon United States Patent Application Publication No. US 2003/0104254).

### SUMMARY OF THE INVENTION

In one form thereof, the invention is a coated cutting insert for use in a chip-forming material removal operation wherein the coated cutting insert comprises a substrate that has a flank surface and a rake surface wherein the flank surface intersects the rake surface to form a cutting edge at the intersection. There is a wear-resistant coating scheme that adheres to at least a portion of the substrate. The wear-resistant coating scheme comprises one or more coating layers of one or more of alumina, hafnia and zirconia. There is a wear indicating coating that adheres to at least a portion of the wear-resistant resistant coating scheme. The wear indicating coating comprises M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0.

In another form thereof, the invention is a coated cutting insert for use in a chip-forming material removal operation. The coated cutting insert comprises a substrate that has a flank surface and a rake surface wherein the flank surface intersects the rake surface to form a cutting edge at the intersection. A wear-resistant coating scheme adheres to at least a portion of the substrate wherein the wear-resistant coating scheme comprises one or more coating layers of one or more of alumina, hafnia and zirconia, and the wear-resistant coating scheme exhibiting compressive residual stress. A wear indicating coating adheres to at least a portion of the wear-resistant coating scheme. The wear indicating coating comprises M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0. After use, the wear indicating coating exhibits a visually perceivable color indication of usage.

In still another form thereof, the invention is a method of making a cutting insert with wear indicating comprising the steps of: providing a substrate with an outer alumina coating layer; applying an as-deposited non-wear indicating coating layer to the alumina coating layer; and treating the non-wear indicating coating layer to convert it to a wear indicating coating layer.

### BRIEF DESCRIPTION OF THE DRAWINGS

The following is a brief description of the drawings that form a part of this patent application:

FIG. 1A is an isometric of a specific embodiment of a coated cutting insert of the invention in an unused condition;

FIG. 1B is an isometric of a specific embodiment of a coated cutting insert of the invention in a used condition wherein the wear-generated removal of the top coating layer presents a visually perceivable indication of usage on the rake face;

FIG. 2 is a schematic view of a specific coating scheme on the surface of a substrate wherein the top coating layers are applied according to the process parameters of Table 1 hereof;

FIG. 3 is a scanning electron microscopy (SEM) black and white photomicrograph in back scattering mode (a scale of 10 micrometers) of the coating scheme for a specific embodiment of the coated cutting insert wherein the substrate, the titanium carbonitride coating layer, the bonding coating layer, the alumina coating layer, the TiAlOCN coating interlayer and the titanium oxycarbonitride top coating later are indicated;

FIG. 4A is a SEM photomicrograph (scale of 20 micrometers) of the surface morphology of a specific embodiment of a cutting insert with an outer coating layer of titanium oxycarbonitride prior to the implementation of the post-coating blasting treatment;

FIG. 4B is a SEM photomicrograph (scale of 20 micrometers) of the surface morphology of a specific embodiment of a cutting insert with an outer coating layer of titanium oxycarbonitride after to the implementation of the post-coating blasting treatment;

FIG. 5A is a bar diagram that shows the magnitude of the compressive stress as measured by an x-ray diffraction technique in the alumina coating for two samples of a prior art coated cutting insert wherein the two samples are shown as cross-hatched and dotted and the average compressive stress is unmarked;

FIG. 5B is a bar diagram that shows the magnitude of the compressive stress (after the post-coating blasting treatment) as measured by an x-ray diffraction technique in the alumina coating for two samples of the inventive cutting insert and wherein the two samples are shown as cross-hatched and dotted and the average compressive stress is unmarked; and

FIG. 6 is a drawing that illustrates the Psi method of measuring stress in the alumina coating layer.

### DETAILED DESCRIPTION

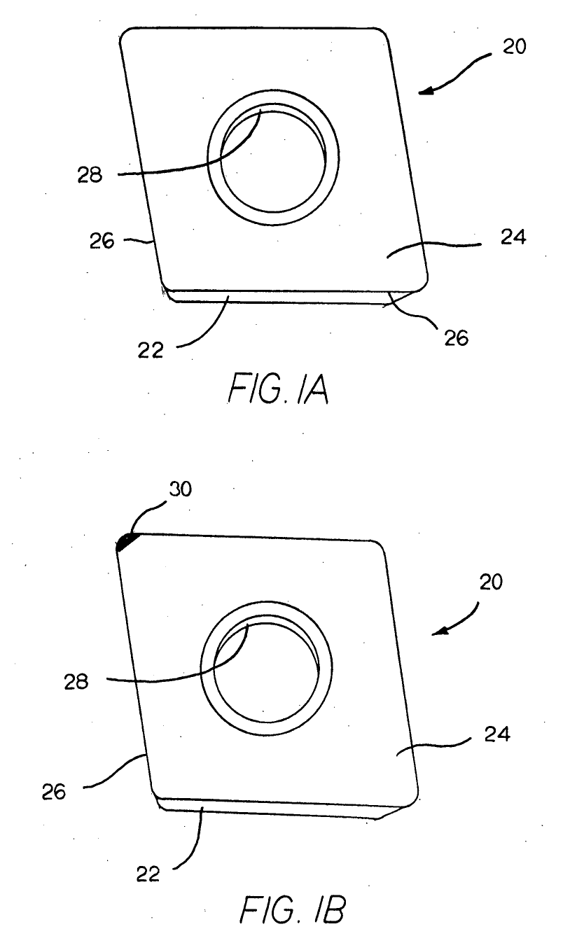

Referring to FIGS. 1A and 1B, there is illustrated a cutting insert generally designated as 20. Cutting insert 20 is useful in a chip-forming material removal operation wherein the cutting insert removes material from a workpiece. In regard to the structure of the cutting insert, cutting insert 20 has a plurality of flank surfaces 22 and a rake surface 24 wherein there is a cutting edge 26 at the juncture of each flank surface 22 and the rake surface 24. Cutting insert 20 thus presents a plurality of cutting edges. Cutting insert 20 further contains a central aperture 28 useful for attachment of the cutting insert to a holder.

As mentioned above, the invention pertains to a coated cutting insert 20 with a wear-resistant coating scheme that exhibits wear indication via visually contrasting colors of an outer wear-indicating coating layer that operatively adheres to an alumina coating layer. A comparison of the rake surfaces of the coated cutting inserts illustrated in FIGS. 1A and 1B demonstrates the way the cutting insert exhibits wear indication. There should be an appreciation that the wear-resistant coating scheme can also indicate wear on the flank surface of the cutting insert.

FIG. 1A shows the cutting insert 20 in an unused condition and FIG. 1B shows the cutting insert 20 in a used condition. When in the unused condition, the outer surface of the cutting insert is substantially uniform or consistent in visual appearance. During the chip-forming material removal operation, chips of the workpiece material pass over the surfaces of the cutting insert so that, for example, the top coating layer wears off to expose the underlying alumina coating layer. There is a visually perceivable color contrast between the top coating layer and the alumina coating layer so that in areas of wear, the darker alumina is perceivable in contrast to the unworn (or less worn) areas. The top coating layer may also visually indicate usage through discoloration caused by thermal oxidation wherein there is a contrast in color between the oxidized top coating layer and the non-oxidized top coating layer. The top coating layer may also visually indicate usage through adherence or build-up of workpiece material on the cutting insert wherein there is a color contrast between the built-up workpiece material and the top coating layer. The visually perceivable area that indicates usage, which can be a worn area, a thermally oxidized area or an area with workpiece material build-up, is designated as 30 in FIG. 1B. The operator can thus look at the cutting insert and discern the used cutting edge(s) from the unused cutting edge(s).

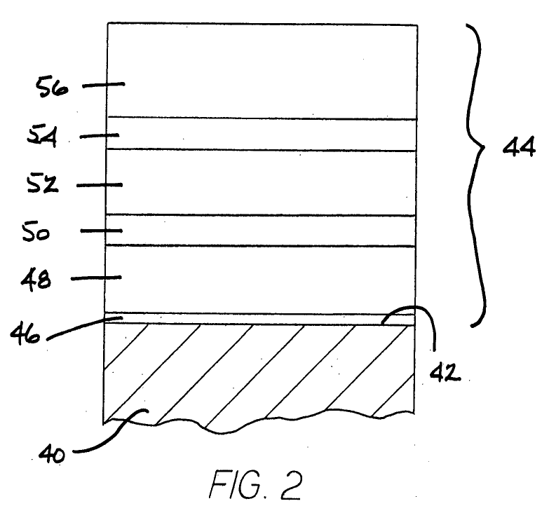

FIG. 2 shows a schematic of a specific embodiment of the coating scheme of the invention applied by chemical vapor deposition to the surface 42 of a substrate 40 according to the process set forth in Table 1 below. For Table 1, the column identified as “Materials” presents the materials of the coating layer, the column identified as “Temperature Range” presents the temperature range (or temperature) in degrees Centigrade (° C.) for the process step to deposit the corresponding coating layer, the column identified as “Pressure range” presents the pressure range in millibars (mb) for the process step to deposit the corresponding coating layer, and the column identified as “Total Time” presents the total duration in minutes for the process step to deposit the corresponding coating layer, and the column identified as “Gases Present” identifies the gases that were present at one time or another for the process step to deposit the corresponding coating layer.

TABLE 1
Process Parameters for Top Layers of Inventive Coated Cutting Inserts

| | | Pressure | Total | |
|---|---|---|---|---|
| | Temperature | Range | Time | |
| Materials | Range (° C.) | (mbar) | (minutes) | Gases Present |
| TiOCN | 980-1000 | 200-500 | 50-100 | H₂ + N₂ + CH₄ + |
| | | | | TiCl₄ + CO |
| TiCN | 980-1000 | 200-500 | 15 | H₂ + N₂ + CH₄ + TiCl₄ |
| TiAlOCN | 980-1000 | 60-150 | 10-25 | H₂ + N₂ + TiCl₄ + |
| | | | | AlCl₃ + CO |

Substrate with α-Al₂O₃ coating layer thereon

The substrates can be made from cemented carbides, carbides, ceramics and cements. A typical cemented carbide is a cemented (cobalt) tungsten carbide wherein the cobalt content ranges between about 0.2 weight percent and about 15 weight percent. In the case of a cemented (cobalt) tungsten carbide, some of the substrates may exhibit a zone of binder enrichment beginning at and extending inwardly from the surface of the substrate. The cemented carbide substrate may also have the following elements and/or their compounds: titanium, niobium, vanadium, tantalum, chromium, zirconium and/or hafnium. When the substrate is a carbide, there is an absence of a binder alloy (e.g., cobalt).

The ceramic substrates include silicon nitride-based ceramics, SiAlON-based ceramics, titanium carbonitride-based ceramics, titanium diboride-based ceramics, alumina-based ceramics, and aluminum oxynitride-based ceramics. Cements substrates include cements that have nickel-cobalt binder and a high level of titanium and could further include tungsten carbide, titanium carbide, and nitrogen.

In regard to the specific embodiment of FIG. 2, the coating scheme (see bracket 44) presents a conventional portion applied by chemical vapor deposition (CVD) wherein the conventional portion comprises:
(A) a titanium nitride base coating layer 46, which has a thickness ranging between greater than 0 micrometers and about 1 micrometers with an alternate range being between greater than 0 micrometers and about 0.5 micrometers, applied to the surface 42 of the substrate 40;
(B) a titanium carbonitride coating layer 48 is applied to the titanium nitride coating layer 46 and wherein the titanium carbonitride coating has a thickness ranging between about 1 micrometer and about 20 micrometers with one alternate range being between about 2 micrometers and about 15 micrometers and still another alternate range being between about 2 micrometers and about 10 micrometers;
(C) a bonding coating layer 50 that contains Ti, Al, O, C and N (as well as some high temperature-CVD titanium carbonitride) applied to the titanium carbonitride coating layer and wherein the bonding coating layer has a thickness ranging between about 0.1 micrometers and about 5 micrometers with an alternate range between about 0.5 micrometers and about 3 micrometers; and
(D) an alpha-alumina coating layer 52 applied to the bonding layer 50 and wherein the alpha-alumina coating layer has a thickness ranging between about 1 micrometer and about 20 micrometers with an alternate range being between 2 micrometers and about 15 micrometers and with still another alternate range being between about 4 micrometers and about 12 micrometers.

In reference to the inventive coating, a coating interlayer of titanium aluminum oxycarbonitride 54 is applied by CVD to the surface of the alpha-alumina coating layer 52. The coating interlayer 54 is of a thickness that ranges between greater than 0 micrometers and about 3 micrometers with an alternate range being greater than 0 micrometers and about 1 micrometer.

The outer coating layer of titanium oxycarbonitride 56, which also includes a base portion of titanium carbonitride to provide a base for the nucleation of the outer coating layer of titanium carbonitride, is applied by CVD to the surface of the coating interlayer 54. The titanium oxycarbonitride (TiOₓC_{y}N_{z} wherein x>0, y>0 and z>0) coating layer 56 is of a thickness that ranges between about 0.1 micrometers and about 3 micrometers with an alternate range being between about 0.5 micrometers and about 2 micrometers.

In the above description, the alpha-alumina coating layer may be a wear-resistant coating scheme which may comprise one or more layers. In this regard, the wear-resistant coating scheme can comprise one or more coating layers of one or more of alumina, hafnia and zirconia, and the wear-resistant coating scheme exhibiting compressive residual stress wherein one range of the compressive residual stress is between about 400 MPa and about 2000 MPa and an alternate range of compressive residual stress is between about 600 MPa and about 1000 MPa.

In the above description, the outer coating layer is titanium oxycarbonitride. There should be an appreciation that the outer coating layer (or wear indicating coating layer) can comprise M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0. When aluminum is present in the “M” component of the wear indicating layer, it is in combination with another one or more of the other elements (i.e., titanium, hafnium, zirconium, chromium). There should be an appreciation that the outer coating layer can include titanium oxycarbide, titanium oxynitride, titanium aluminum oxycarbide, or titanium aluminum oxynitride.

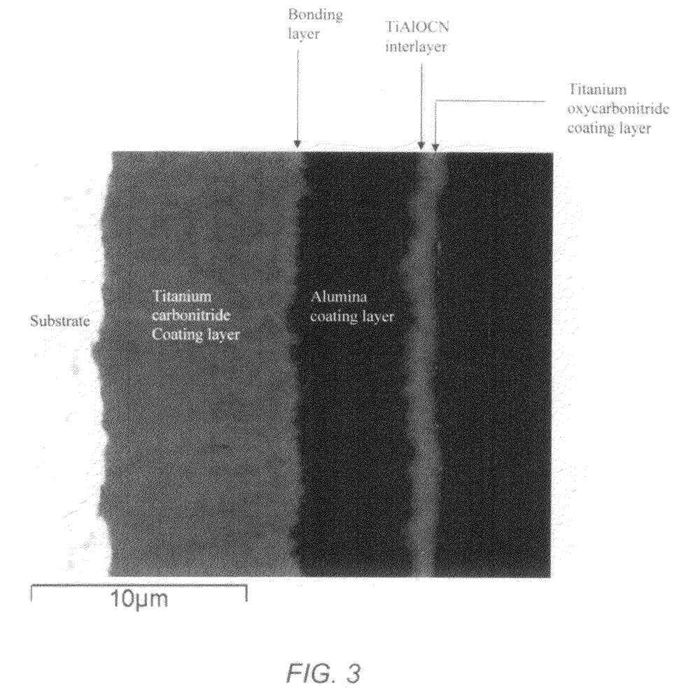

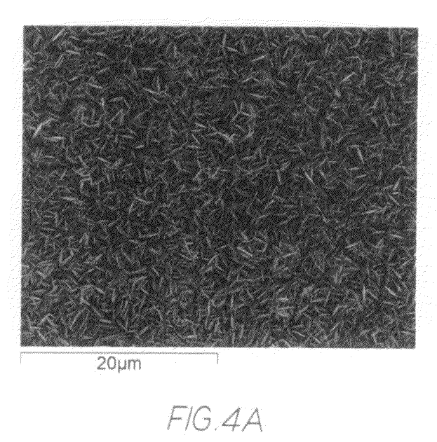

FIG. 3 is a SEM back scattered image (scale of 10 micrometers) that shows a polished substrate/coating cross section of an inventive cutting insert. In FIG. 3, the substrate is a cemented (cobalt) tungsten carbide and exhibits a light color. The substrate has a surface on which there is a light gray titanium carbonitride coating layer. There should be an appreciation that a very thin base layer of titanium nitride exists, but is not visible in the photomicrograph. A bonding layer that contains Al, Ti, O, C and N is on the surface the titanium carbonitride coating layer. A darker alpha-alumina coating layer is on the bonding layer. A titanium aluminum carbo-oxynitride interlayer coating is on the surface of the alpha-alumina coating layer.

Finally, a light gray outer coating layer of titanium oxycarbonitride, which also includes a base layer of titanium carbonitride as a base for nucleation of the titanium oxycarbonitride, is on the titanium aluminum carbo-oxynitride interlayer.

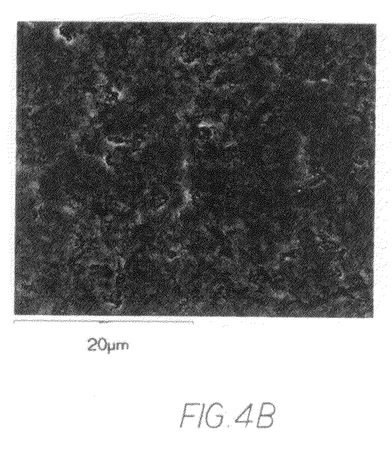

FIGS. 4A and 4B are photomicrographs that show the SEM image of the titanium oxycarbonitride top layer. FIG. 4A shows the surface of the titanium oxycarbonitride top layer after coating and prior to subjection to a mechanical post-coating treatment, which in this case is blasting. FIG. 4B shows the surface of the titanium oxycarbonitride top layer after the blasting surface treatment. While wet blasting is preferred, other kinds of blasting treatments can be suitable.

As shown in FIG. 4A, prior to blasting, the titanium oxycarbonitride top layer exhibits platelet morphology with very high two-dimensional aspect ratio. The nature of platelet crystalline structure results in more scattering of the light making the coating surface appear to be black or dark red prior to the blasting surface treatment wherein a coating layer with the black or dark red color surface is not suitable to function as a wear indicating layer. As shown in FIG. 4B, after the blasting surface treatment, the coating surface is smoothened and appears in the actual sample to be of a bronze color wherein a coating layer with a bronze color is suitable as a wear indicating layer. The surface roughness (Rₐ) of the blasted outer surface of two samples of the inventive coated cutting inserts was 340 nm±6 nm for one sample and 352 nm±4 nm for the second sample.

In addition to smoothing the surface of the outer coating layer, the blasting treatment converts the as-deposited outer coating layer from a coating layer not suitable to be a wear indicating layer into a coating layer that is suitable to be a wear indicating coating layer. The blasting the surface of the outer coating layer resulted in a change in the color of the coating layer from a black or dark red (i.e., a dark color) to a bronze (i.e., a lighter color). There should be an appreciation that a coating layer with a dark color is unsuitable as a wear indicating layer and a coating layer with a lighter color is suitable as a wear indicating coating layer. When the outer coating layer is a lighter color, it is able to provide an indication of wear through any one or more of the following mechanisms that occur during use: discoloration of the cutting insert, build-up of the workpiece material on the cutting insert, or the removal of the outer coating layer to expose the alumina coating layer which has a visually perceivable color contrast with the outer coating layer.

Still another result of blasting is the reduction of the tensile residual stress levels in the alumina coating layer from the levels extant in the as-deposited alumina coating layer. The reduction can be such to reduce the amount of tensile residual stress wherein the stress remains tensile or it can be such to reduce the residual stresses into being compressive residual stress.

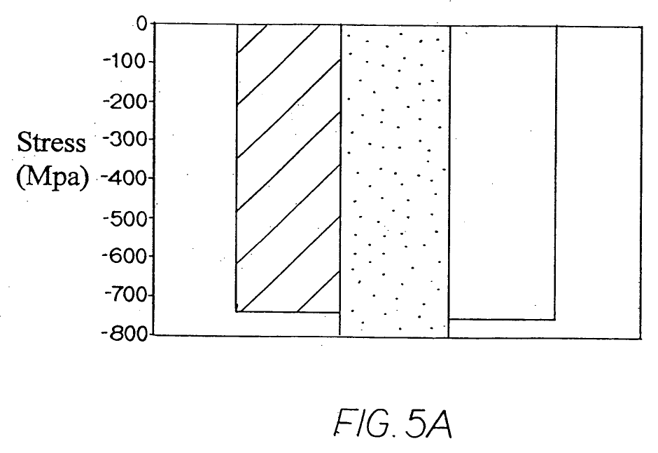

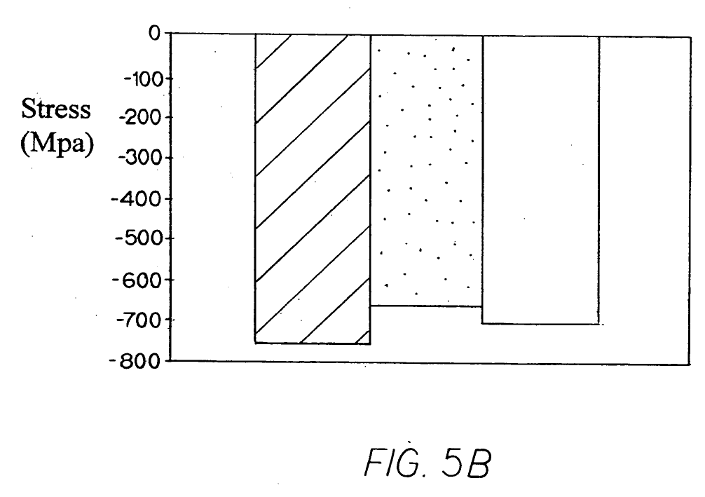

In reference to the impact of the use of the post-coating blasting treatment to reduce the residual stresses present in the alumina coating layer after coating, FIG. 5A is a bar diagram that shows the magnitude of the compressive stress as measured by an x-ray diffraction technique in the alumina coating for two samples of a prior art cutting insert. In FIG. 5A, the two prior art samples are shown by the bars that are cross-hatched and dotted and the average compressive stress is shown by the unmarked bar. FIG. 5B is a bar diagram that shows the magnitude of the compressive stress (after the post-coating blasting treatment) in the alumina coating layer as measured by an x-ray diffraction technique for two samples of the inventive cutting insert. In FIG. 5B, the two inventive samples are shown by the bars that are cross-hatched and dotted and the average compressive stress is shown by the unmarked bar. For each one of FIGS. 5A and 5B, the stress is reported in MPa.

As shown by FIG. 5B, the compressive residual stress in the alumina for the inventive samples is in the range of between about −650 MPa and −800 MPa. While the maximum amount of compressive stress can vary depending upon the coating composition, the coating thickness, the coating application technique, or the coating-substrate thermal coefficient of expansion mismatch, it is contemplated that the maximum compressive stress is about 2 GPa. There should be an appreciation that the compressive residual stress in the alumina coating layer of the inventive samples is in the same range as the compressive residual stress in the alumina coating layer of the prior art cutting inserts; however, in the case of the present invention, the outer wear indicating layer remains in place through the blasting treatment in contrast to the prior art cutting insert due to the improved bond strength to the alumina of the outer coating layer of the invention, as well as improved abrasion resistance of the outer coating layer to the blasting process.

The XRD residual stress in the alumina coating layer was measured by a Psi tilt method and the reflection (024) in the alumina coating layer was chosen for the measurement. Psi tilts of 0, 33.9, 52.1 and 75 degrees were selected for the measurement of the residual stress levels. Positive and negative Psi tilts were chosen to supply the data required to determine possible shear stresses. Additionally, three Phi rotation angles were selected (0, 45, and 90) to provide the data required to determine the biaxial stress state of the material.

Biaxial stress calculations were completed using the following equation:

$$\frac{{d}_{ϕψ} - {d}_{0}}{{d}_{0}} = {S}_{1} ( {σ}_{1} + {σ}_{2} ) + \frac{1}{2} {S}_{2} {σ}_{ϕ} {sin}^{2} ψ$$

where: S₁ and ½ S₂ are the x-ray elastic constants
d_{φψ} measured peak d-spacing for the Psi tilt and Phi rotation
d₀ stress free peak d-spacing for diffracted reflection

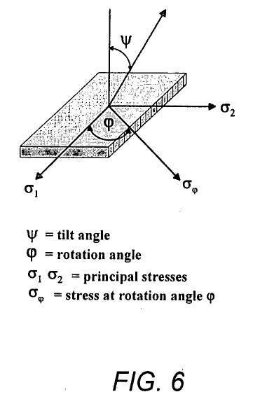

σ_{φ}=σ₁ cos² φ+σ₂ sin² φ
σ₁ and σ₂ are the primary stresses
   The relationship of the various tilt and rotation angles in this method is shown in FIG. 6. Young's Modulus (E) is taken to be 401 GPa, Poisson's Ratio (v) is taken to be 0.22, and x-ray elastic constants (S₁ and S₂) are taken to be −0.53×10⁶ mm²/N and 2.94×10⁶ mm²/N respectively for calculation of stress in Al₂O₃ coating.

Cutting tests were conducted to compare the inventive coated cutting inserts against the prior art cutting inserts. The inventive cutting inserts in these tests were made according to the process set forth in Table 1. The prior art cutting insert exhibited a coating scheme like that of the inventive samples, except that the outer layer of the prior art cutting inserts comprised alpha-alumina that had been blasted to reduce the residual to compressive residual stress. Prior to the blasting of the prior art cutting inserts, the alumina coating layer was covered by a TiN/TiCN layer. However, the blasting removed the TiN/TiCN layer to expose the alumina coating layer as the black outer layer.

The substrates for both the prior art cutting inserts and the inventive cutting inserts comprised cemented (cobalt) tungsten carbide with the following approximate composition: 1.8 weight percent tantalum, 0.4 weight percent titanium, 0.3 weight percent niobium, 6 weight percent cobalt and the balance tungsten carbide and recognized impurities.

In reference to the metalcutting tests, the parameters of test were as follows:
Insert style: CNMA432
Lead angle: −5 degree
Work piece materials: 80-55-06 ductile iron
Operation: Wet turning cycle interrupted cut
Speed: 656 surface feet per minute
Feed rate: 0.004 inch per revolution
Depth of cut: 0.08 inch
   The failure criteria were: flank wear, nose wear and depth of cut notching (DOCN) equal to 0.012 inches (0.0305 millimeters). For these tests, the failure mode was depth of cut notching and flank wear. The test results are set out in Table 2 and Table 3.

TABLE 2
Tool life test result (in minutes) for Prior Art Cutting
Inserts and Inventive Cutting Inserts

| | | | Average of |
|---|---|---|---|
| Test candidates | Rep. 1 | Rep. 2 | tool life |
| Prior Art Insert | 7.3 | 7.0 | 7.2 |
| Inventive Insert | 9.4 | 7.4 | 8.4 |

TABLE 3
Tool life test result (in minutes) for Prior Art Cutting
Inserts and Inventive Cutting Inserts

| Test | | | | Average |
|---|---|---|---|---|
| candidates | Rep. 1 | Rep. 2 | Rep. 3 | of tool life |
| Prior Art Insert | 11.5 | 16.6 | 10.7 | 13.0 |
| Inventive | 12.5 | 12.9 | 9.7 | 11.7 |
| Insert | | | | |

Table 2 and Table 3 indicate that the cutting insert of the invention shows similar tool life on the average with the prior art cutting insert. However, The cutting insert of the invention possesses better edge identification ability compared to prior art cutting insert.

It can be appreciated that the present invention provides an improved coating cutting insert with wear (or usage) indication properties. These properties utilize a color contrast on the wear indicating coating layer, which in the unused condition presents substantially uniform or consistent visual appearance. However, if during usage the wear indicating coating layer is removed to expose the underlying wear-resistant coating layer (e.g., an alumina coating layer), there is a visually perceivable color contrast between the top coating layer and the alumina coating layer to indicate usage or wear. The top coating layer may also visually indicate usage through discoloration caused by thermal oxidation wherein there is a contrast in color between the oxidized top coating layer and the non-oxidized top coating layer. The top coating layer may also visually indicate usage through adherence or build-up of workpiece material on the cutting insert wherein there is a color contrast between the built-up workpiece material and the top coating layer. The operator can thus look at the cutting insert and discern the used cutting edge(s) from the unused cutting edge(s).

Further, the present invention provides such a cutting insert that exhibits a smooth surface. In addition, the present invention provides a cutting insert that enhances useful tool life, as well as has both wear indication properties and a smooth surface.

All patents, patent applications, articles and other documents identified herein are hereby incorporated by reference herein. Other embodiments of the invention may be apparent to those skilled in the art from a consideration of the specification or the practice of the invention disclosed herein. It is intended that the specification and any examples set forth herein be considered as illustrative only, with the true spirit and scope of the invention being indicated by the following claims.

What is claimed is:

1. A coated cutting insert for use in a chip-forming material removal operation, the coated cutting insert comprising:
a substrate having a flank surface and a rake surface wherein the flank surface intersects the rake surface to form a cutting edge at the intersection;
a wear-resistant coating scheme adhering to at least a portion of the substrate, and the wear-resistant coating scheme comprising one or more coating layers of one or more of alumina, hafnia and zirconia; and
a wear indicating coating adhering to at least a potion of the wear-resistant coating scheme, and the wear indicating coating comprising M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0.

2. The coated cutting insert according to claim 1 wherein the wear-resistant coating scheme comprising alumina, and M is titanium.

3. The coated cutting insert according to claim 1 wherein the wear-resistant coating scheme comprising alumina, and M is titanium-aluminum.

4. The coated cutting insert according to claim 1 wherein the wear-resistant coating scheme exhibiting reduced tensile to compressive residual stress.

5. The coated cutting insert according to claim 1 wherein the wear-resistant coating scheme exhibiting compressive residual stress.

6. The coated cutting insert according to claim 1 wherein the wear-indicator coating layer maintains adherence to the wear-resistant coating scheme through a post-coating mechanical treatment.

7. The coated cutting insert accruing to claim 1 wherein the wear indicating coating being on at least a portion of the rake face and at least a portion of the flank face.

8. The coated cutting insert according to claim 1 wherein the substrate presents a plurality of the cutting edges and wherein a selected one of the cutting edges is in engagement with the workpiece during the chip-forming material removal operation, and the wear indicating coating providing a visually perceivable indicator that the selected one of the cutting edges has been in use.

9. The coated cutting insert according to claim 1 wherein the wear indicating layer has a thickness ranging between greater than 0 micrometers and about 5 micrometers.

10. The coated cutting insert according to claim 1 wherein the wear indicating layer has a thickness ranging between greater than 0.1 micrometers and about 3 micrometers.

11. The coated cutting insert according to claim 1 wherein the wear indicating layer has a thickness ranging between greater than 0.5 micrometers and about 2 micrometers.

12. The coated cutting insert according to claim 1 wherein the wear-resistant coating scheme exhibiting a compressive residual stress in the range of between about 400 MPa and about 2000 MPa.

13. The coated cutting insert according to claim 1 wherein the wear-resistant coating scheme exhibiting a compressive residual stress in the range of between about 600 MPa and about 1000 MPa.

14. A coated cutting insert for use in a chip-forming material removal operation, the coated cutting insert comprising:
a substrate having a flank surface and a rake surface wherein the flank surface intersects the rake surface to form a cutting edge at the intersection;
a wear-resistant coating scheme adhering to at least a portion of the substrate, and the wear-resistant coating scheme comprising one or more coating layers of one or more of alumina, hafnia and zirconia, and the wear-resistant coating scheme exhibiting compressive residual stress;
a wear indicating coating adhering to at least a portion of the wear-resistant coating scheme, and the wear indicating coating comprising M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0; and
after use, the wear indicating coating exhibiting a visually perceivable color indication of usage.

15. The coated cutting insert according to claim 14 wherein the wear-resistant coating scheme comprising alumina, and M is selected from the group comprising titanium and titanium-aluminum.

16. The coated cutting insert according to claim 14 wherein the wear-indicator coating layer maintains adherence to the wear-resistant coating scheme through a post-coating mechanical treatment.

17. The coated cutting insert accruing to claim 14 wherein the wear indicating coating being on at least a portion of the rake face and at least a portion of the flank face.

18. The coated cutting insert according to claim 14 wherein the substrate presents a plurality of the cutting edges and wherein a selected one of the cutting edges is in engagement with the workpiece during the chip-forming material removal operation, and the wear indicating coating providing a visually perceivable indicator that the selected one of the cutting edges has been in use.

19. The coated cutting insert according to claim 14 wherein the wear indicating layer has a thickness ranging between greater than 0 micrometers and about 5 micrometers.

20. The coated cutting insert according to claim 14 wherein the wear-resistant coating scheme exhibiting a compressive residual stress in the range of between about 400 MPa and about 2000 MPa.

21. The coated cutting insert according to claim 14 wherein the wear-resistant coating scheme exhibiting a compressive residual stress in the range of between about 600 MPa and about 1000 MPa.

22. A method of making a cutting insert with wear indicating comprising the steps of:
providing a substrate with an outer alumina coating layer;
applying an as-deposited non-wear indicating coating layer to the alumina coating layer; and
treating the non-wear indicating coating layer to convert it to a wear indicating coating layer.

23. The method of making a cutting insert according to claim 22 wherein the non-wear indicating coating layer comprising M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0.

24. The method of making a cutting insert according to claim 22 wherein the wear indicating coating layer comprising M(OₓC_{y}N_{z}) wherein M is selected from the group comprising one or more of the following titanium, hafnium, zirconium, chromium, titanium-aluminum alloy, hafnium-aluminum alloy, zirconium-aluminum alloy, chromium-aluminum alloy, and their alloys, and x>0, y≧0, z≧0 and y+z>0; and the wear indicating coating layer exhibiting a color visually perceivable from the color of the alumina coating layer.

25. The method of making a cutting insert according to claim 22 wherein the wear indicating coating layer has a thickness ranging between greater than 0 micrometers and about 5 micrometers.

26. The method of making a cutting insert according to claim 22 wherein the treating step comprises blasting.
